(19) United States
(12) Patent Application Publication
(10) Pub. No.: US 2025/0212009 A1
(43) Pub. Date: Jun. 26, 2025

(54) WIRELESS ACCESS POINT INSTALLATION MANAGEMENT

(71) Applicant: Charter Communications Operating, LLC, St. Louis, MO (US)

(72) Inventors: Pareshkumar Panchal, Highlands Ranch, CO (US); Muhib Taiye Oduwaiye, Aurora, CO (US); Clyde A. Chappell, Aurora, CA (US); Arvind Kopparapu, Parker, CO (US); Noah Y. Polizzotto, Castle Rock, CO (US)

(21) Appl. No.: 18/390,826

(22) Filed: Dec. 20, 2023

(51) Int. Cl. H04W 16/18; H04W 16/24

(52) U.S. Cl. CPC H04W 16/18; H04W 16/24

(57) ABSTRACT

Communication management hardware receives input indicating an alternative site in which to install a first wireless access point. The alternative site is different than an original site selected for installation of the first wireless access point. The communication management hardware predicts a wireless coverage associated with installation of the first wireless access point at the alternative site. Based on the predicted wireless coverage, assigning a performance metric to the installation of the first wireless access point at the alternative site. The communication management hardware can be configured to wirelessly transmit the performance metric to an installation technician for review. The installation technician may select the alternative site based upon the performance metric.

### BACKGROUND

Conventional wireless technology has been used for many years to connect wireless devices such as phones, laptops, etc., to a landline network and other wireless networks. Today, such wireless networks support many different types of connection services such as voice communications, cell communications, high-speed data services, Wi-Fi™ connectivity, and so on.

Cellular networks typically include a land area that has been divided into so-called cellular regions. A single base station typically resides in each cell. Often, the base station is connected to a landline network and supports communication with one or more wireless subscribers operating in a region covered by the cell. Accordingly, a wireless subscriber operating a cell phone in the cell is able to communicate with or have access to a landline network and remote network via a wireless link between the subscriber and a base station.

Conventional long-range cellular networks sometimes do not have the ability to provide connectivity to users at every location in a geographical region. One reason for this shortcoming is the high cost associated with designing and subsequently implementing a long-range cell tower for every portion of a geographical region. In many instances, a cell tower providing long-range coverage requires a long-term financial commitment. In certain instances, because costs are so high, a service provider may not even install a cell tower because it is not a good investment.

More recent wireless technology includes so-called pico base stations or Wi-Fi™ stations having the ability to provide short-range coverage compared to long-range coverage provided by conventional cell towers. Typically, the short-range base stations have the ability to provide coverage in locations that were not previously possible. As an example, a pico base station may provide radial coverage on the order of 50-200 meters. A long-range base station or conventional cell tower may provide wireless coverage on the order of a mile or more.

Because of cost concerns and higher re-usage of frequencies in the RF spectrum in smaller regions, it is now becoming more common to implement one or more pico base stations to provide additional wireless coverage in a region. Small cell base station deployment may increase the number of cells in a given area, and thereby, improve the overall network capacity without adding more RF spectrums. In certain cases, a short-range base station can be mounted to existing infrastructure (e.g., a cable), alleviating the costs associated with having to design and erect a dedicated tower.

In a typical cellular network environment, after completion of an RF network design, field teams such as technicians are deployed via truck rolls to complete the survey of available alternate candidates in the area prior to installation of proposed wireless access points. More than 70% of the time, actual proposed installation locations are not feasible or available in accordance with desired antenna height, azimuth etc. In order to maintain the network quality as per network design coverage & quality targets, it is important to maintain accuracy of alternate candidates so that the network will provide better coverage and wireless service quality target instead of degrading the coverage in wireless service.

For example, assume that a proposed RF site A location was at [x1,y1] latitude and longitude with antenna height of 10 meters. During a survey at the proposed location, assume that the technician finds that resources associated with the location actually reside at location [a1,b1] and antenna height of 7 m. This new alternate site A location is 100 m away from [x1,y1] along with lower available antenna height. In such an instance, the installation technician is not able to install the new wireless access point at the proposed site A location. Also in multiple instances, a proposed RF site A location will move in the direction or vicinity of neighbor site B, so there will be coverage overlapping, which may lead to less coverage gain than expected.

### BRIEF DESCRIPTION OF EMBODIMENTS

This disclosure includes a candidate evaluation tool which can be used by any of the field crews (installation technicians) as well as internal design teams by using one or more application programming interface (APIs) for coverage predictions and matrix calculation. Further, implementation of the techniques herein also may human intervention by auto loading the alternative candidate site information and passing it through workflows along with notifications to respective appropriate teams. This solution will automatically maintain appropriate database fields as selected by engineers which can be used for plug and play type of network integration and commissioning.

In order to leverage the automation capability of available predictions models APIs, it can be accessed through APIs (application programming interfaces) which will be used for coverage and interference predictions.

Listed below are the summary from this automation effort:
1. On FieldOps/Site Acquisition/Deployment profile, generate RF predictions at site and cluster using automation platform using prop APIs for RSRP, SINR and Traffic. Also provide 2 additional alternate candidates asides new propagation.
2. On RAN Design profile, generate predictions with prop APIs using automation platform to capture RSRP, SINR, best server plots, for both site candidates and cluster. Also generate RF stats at cell, site and cluster level. A cluster can be defined as a group of sites mapped by RF engineer or it can be defined as a list of sites within specified distance criterion (radius).
3. Notification to RF team/respective teams through email in dashboard summary
4. Process to capture justification for change and track request for posterity purposes. e.g. telco cable clearance, foliage, pole integrity, nonexistent pole, others etc.
5. Present summary of progress and notifications/changes in to relevant teams as close as possible to real time.
6. Allow Field teams, Site Acquisition or Real Estate team to visualize RF plots over a map from field to make viable inputs for RF teams decision making (Note: This should not impact RAN Design master DB until approved by team and should be reversible)
7. Accommodate Approval or rejections to update relevant reference information in planning tool database and maintain history of records
8. Auto generation of plug and play database.

### Network Automation System:

This section describes the overview of RF automation process flow.
RF design team will provide Initial go to market RF design with necessary RF planning info including tonnage map locations and all necessary info sufficient to run predictions and interference etc.
Field Operations, Site Acquisitions, Real estate or RF teams will have ability to update specific sites lat, long, height and azimuth information (for new candidates evaluation). New candidate will be replaced with nominal sites id followed by “_R1” or “R2” etc.,
RF team should have the ability to approve or reject the candidates (refer section 4 of this document).
At Each Milestone, respective team should be able to provide Comment in a given box with visibility on history of records including conditional approvals etc.
Coverage layers (RSRP, SINR and Coverage by transmitter) should be overlaid on a map with all the design sites.
There will be multiple sets of coverage layer to be ran (refer section 5 of this document)
Set 1: Site (coverage layer of specific nominal site)
Set 2: Site (coverage layer of candidate of nominal site)
Set 3: Cluster (cluster/group level coverage layer with specific nominal site)
Set 4: Cluster (cluster/group level coverage layer with candidate of nominal site)
Based on any Site or group of sites, RF team should be able to produce coverage layers and statistics of respective sites or clusters.
RF team should be able to update relevant parameters such as propagation models, transmit powers, antenna allocation, latitude, longitude, azimuth, height, coverage thresholds (such as proposed installation at a particular site providing sufficiently large area coverage, sufficiently high signal power to the area of coverage, etc.), etc., and re-run prediction plots or statistics as needed
RF coverage statistics (area covered, SINR covered and captured tonnage) will be generated for all of the above set of layers for given ranges with ability to modify ranges for statistics including percentile levels (for example: 50th Percentile of SINR value)
Comparison analysis should be calculated with reference to nominal specification vs candidate site. Same will be applicable for group of sites level calculation. Statistical calculation can be categorized as <60 (Red), 60˜80% (Yellow) and >80% (Green) ranges compared with nominal and candidate for area, interference and traffic bins.
RF team should have the ability to modify/update thresholds, border, colors, symbols etc. on which layers or statistics are being generated.
Notifications should be sent to relevant team on specific milestones described in workflow via email.
Relevant RF information after approval need to be updated in to master file for further consumption
Tool should work with GIS automation export of respective coverage layers
Plug and Play database should be generated by exporting selective fields from cell, transmitter and site table including map layer for each site after RF approval completion

Accordingly, techniques as discussed herein provide improved efficiency of installing and operating wireless access networks and expand use of limited wireless bandwidth in a network environment.

More specifically, a communication management resource (a.k.a., configuration management resource) receives input indicating an alternative site (such as one of multiple proposed alternative sites) in which to install a first wireless access point. The alternative site is different than an original site selected for installation of the first wireless access point. Via an analyzer, the communication management resource predicts a wireless coverage associated with installation of the first wireless access point at the alternative site. Based on the predicted wireless coverage, the communication management resource initially assigns a performance metric to the installation of the first wireless access point at the alternative site. In one example, the performance metric indicates a degree to which the alternative site supports wireless services in a geographical region. The communication management resource can be configured to wirelessly transmit the performance metric to an installation technician for review. The installation technician may select the alternative site based upon the performance metric.

In accordance with further examples, the input indicating the alternative site is generated by a respective installation technician surveying the original site. The respective installation technician may generate the input indicating the alternative site based upon an in-person survey by the respective installation technician in a geographical region including the original site. The respective installation technician may generate the input in response to detecting a deficiency or impediment associated with installation of the first wireless access point at the original site.

In further examples as discussed herein, the communication management resource may reject installation of the first wireless access point at the alternative site in response to detecting that the performance metric assigned to the alternative site is below a threshold level. If desired, the communication management resource can be configured to provide notification of the rejection to a respective installation technician generating the input.

In accordance with still further examples, the communication management resource can be configured to perform a preliminary analysis of the first wireless access point providing the wireless coverage at the alternative site. The communication management resource produces the performance metric associated with the installation of the first wireless access point at the alternative site based on the preliminary analysis. Thereafter, the communication management resource provides notification of the performance metric to an installation technician for review. As previously discussed, the installation technician is assigned to install the first wireless access point at the original site. The installation technician communicates a message indicating selection of the alternative site for installation of the first wireless access point instead of installation at the original site based on the performance metric (such as indicating that installation at the alternative site is likely to provide equivalent wireless coverage or ubiquitous coverage as designed). Thus, the communication management resource receives the message indicating the selection of the alternative site.

In response to receiving the message indicating selection of the alternative site by the installation technician, the communication management resource performs a secondary analysis of installing the first wireless access point at the alternative site. In one example, the secondary analysis is more robust (more thorough) than the preliminary analysis. Based on the secondary analysis, and assuming that the secondary analysis indicates that installation of the first wireless access point at the alternative site is predicted to provide wireless coverage above a threshold level without causing undue interference to other wireless access points, the communication management resource generates a decision approving installation of the first wireless access point at the alternative site. The communication management resource or other suitable entity communicates the decision in a message over a wireless communication link to the installation technician. The decision in the message communicated to the communication device of the installation technician prompts the installation technician to install the first wireless access point at the alternative site.

Note that the input such as from a corresponding installation technician may include notification of multiple alternative sites which to potentially install the first wireless access point such as during a condition in which the installation technician determines an impediment associated with installation of the first wireless access point at the original site. A similar manner as previously discussed, the communication management resource performs a preliminary analysis to predict different wireless coverages associated with multiple alternative sites, each of which is different than the original site.

Based upon the predicted wireless coverages, the communication management resource generates a respective performance metric associated with each of the different alternative sites. For example, during a preliminary analysis of proposed alternative sites, the communication management resource produces a first performance metric for a predicted first wireless coverage associated with installation of the first wireless access point at a first alternative location as proposed by the installation technician. The communication management resource produces a second performance metric for a predicted second wireless coverage associated installation of the first wireless access point at the second alternative location as proposed by the installation technician.

Accordingly, based on the preliminary predicted first wireless coverage, the communication management resource produces a first performance metric (expected performance level) associated with installation of the first wireless access point at the first alternative site. Based on the predicted second wireless coverage via the preliminary analysis, the communication management resource assigns a second performance metric (expected performance level) to the installation of the first wireless access point at the second alternative site. The communication management resource predicts a second wireless coverage associated with installation of the first wireless access point at the second alternative site. Based on the predicted second wireless coverage, the communication management resource assigns a second performance metric to the installation of the first wireless access point at the second alternative site.

The communication management resource communicates the first performance metric and the second performance metric to the installation technician assigned to installation of the first wireless access point. In one example, the first performance metric indicates a first ranking of installing the first wireless access point at the first alternative site. The second performance metric indicates a second ranking of installing the first wireless access point at the second alternative site. Assume that the second ranking is higher than the first ranking meaning that it appears that installation of the first wireless access point at the second alternative site is likely to provide better wireless performance and installation of the first wireless access point at the first alternative site.

In accordance with further examples, the installation technician may provide further input indicating selection of the first alternative site or the second alternative site based upon the ranking of the first metric and the second metric. Assume that the installation technician provides further feedback to the communication management resource indicating selection of the first wireless access point at the second alternative site.

Prior to installation of the first wireless access point at the second alternative site proposed and subsequently selected by the installation technician, the communication management resource implements a secondary analysis of implementing the first wireless access point at the selected second alternative site. The secondary analysis may be more robust than the preliminary analysis used to produce the first metric and the second metric.

In one example, via the secondary analysis, the communication management resource performs an analysis as to whether the installation of the first wireless access point at the second alternative site will provide appropriate wireless coverage and corresponding wireless services above a quality threshold (such as proposed installation at a particular site providing sufficiently large predicted area of wireless coverage, sufficiently high predicted signal power to communication devices in the area of coverage without a significant increase in wireless interference in the network, etc.). If the secondary analysis provides results indicating that the installation of the first wireless access point at the selected second alternative site is greater than the quality threshold, the communication management resource transmits a respective notification to the installation technician that installation of the first wireless access point at the second alternative site has been approved. Alternatively, if the secondary analysis provides results indicating that the installation of the first wireless access point at the selected second alternative site is below the quality threshold, the communication management resource transmits a respective notification to the installation technician that installation of the first wireless access point at the second alternative site has been rejected.

These and other examples are further discussed herein.

Note that the examples as discussed herein are useful over conventional techniques. For example, implementation of a communication management resource (a.k.a., configuration management resource) and corresponding operations as discussed herein provide more efficient deployment of wireless networks and improved wireless coverage to provide wireless connectivity to different users.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including computer readable hardware storage on which software instructions are encoded for subsequent execution. The computer-readable storage hardware for storing instructions may be configured as a non-transitory computer-readable storage medium. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on computer-readable storage hardware such as a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment herein includes computer-readable storage hardware and/or system having instructions stored thereon. The instructions, when executed by the computer processor hardware, cause the computer processor hardware (such as one or more co-located or disparately processor devices or hardware) to: receive input indicating an alternative site in which to install a first wireless access point, the alternative site being different than an original site selected for installation of the first wireless access point; predict a wireless coverage associated with installation of the first wireless access point at the alternative site; and based on the predicted wireless coverage, assigning a performance metric to the installation of the first wireless access point at the alternative site.

Another embodiment herein includes computer-readable storage hardware and/or system having instructions stored thereon. The instructions, when executed by the computer processor hardware, cause the computer processor hardware (such as one or more co-located or disparately processor devices or hardware) to: transmit a site plan to a communication device operated by installation technician, the site plan indicating an original site (such as a first physical location) selected for installation of a first wireless access point; receive input indicating one or more alternative sites in which to install the first wireless access point, the alternative sites being different than the original site selected for installation of the first wireless access point; predict a wireless coverage associated with installation of the first wireless access point at each of the alternative sites; based on the predicted wireless coverage, assign a performance metric associated with predicted operation of the first wireless access point at each of the alternative sites; provide notification of the performance metrics to the installation technician for review, the installation technician assigned to install the first wireless access point at the original site; receive a message from the communication device operated by the installation technician, the message indicating selection of a given alternative site of the one or more alternative sites by the installation technician in which to install the first wireless access point; in response to receiving the message indicating selection of the given alternative site by the installation technician, perform a secondary analysis of installing the first wireless access point at the given alternative site, the secondary analysis being more robust than the preliminary analysis; based on the secondary analysis, generate a decision approving or rejecting installation of the first wireless access point at the given alternative site; in response to approving installation of the first wireless access point at the given alternative site, communicate the decision in a message over a wireless communication link to the installation technician, the decision in the message prompting the installation technician to install the first wireless access point at the alternative site.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity via efficient implementation of wireless base stations in a network environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating implementation of a communication management system and related components in a network environment for implementation of wireless access points as discussed herein.

FIG. 2 is an example diagram illustrating a wireless access point installation technician surveying a geographical region for installation of a wireless access point as discussed herein.

FIG. 3 is an example diagram illustrating a site management system and flow of communications amongst the different entities in a network environment as discussed herein.

FIG. 4 is an example diagram illustrating a proposed original location in which to install a corresponding new wireless access point as discussed herein.

FIG. 5 is an example diagram illustrating the proposed original location in the geographical region as discussed herein.

FIG. 6 is an example diagram illustrating input from a respective installation technician specifying multiple alternative proposed locations in which to potentially install a wireless access point as discussed herein.

FIG. 7 is an example diagram illustrating communication of a ranking of the multiple alternative proposed installation sites as discussed herein.

FIG. 8 is an example diagram illustrating communication of a selected installation site from a ranking and receipt of a final wireless network installation plan as discussed herein.

FIG. 9 is an example diagram illustrating installation of the wireless access point at the selected installation site as discussed herein.

FIG. 10 is an example diagram illustrating an example prediction of wireless coverage workflow as discussed herein.

FIG. 11 is an example diagram illustrating an RF design automation workflow as discussed herein.

FIG. 12 is an example diagram illustrating example computer hardware and software operable to execute operations according to embodiments herein.

FIG. 13 is an example diagram illustrating a method according to embodiments herein.

FIGS. 14 and 15 are example diagrams illustrating a method facilitating installation of a respective wireless access point as described herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DESCRIPTION OF EMBODIMENTS

In one example as discussed herein, a communication management resource receives input indicating an alternative site in which to install a first wireless access point. The alternative site is different than an original site selected for installation of the first wireless access point. The communication management resource predicts a wireless coverage associated with installation of the first wireless access point at the alternative site. Based on the initial predicted wireless coverage, assigning a performance metric to the installation of the first wireless access point at the alternative site. As previously discussed, the performance metric may indicate a predicted ability of the new wireless access point to provide desired wireless services to a corresponding geographical region to be serviced by the wireless access point. The communication management resource can be configured to wirelessly transmit the performance metric to an installation technician for review. The installation technician may select the alternative site based upon the performance metric. In response to receiving final selection of the alternative site by the installation technician, the communication management resource as discussed herein performs a final more robust analysis to determine whether or not to reject or approve installation of the first wireless access point at the selected alternative site.

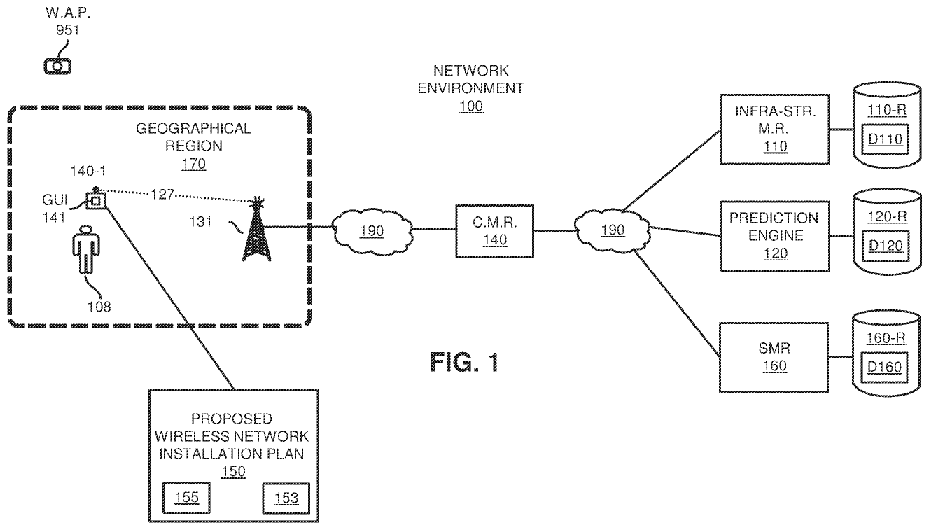

FIG. 1 is an example diagram illustrating implementation of a communication management system supporting more efficient installation of wireless access points in a network environment as discussed herein.

As shown in FIG. 1, the network environment 100 includes communication device 140-1 (such as a wireless handheld device, configuration management resource, or other suitable entity) operated by the installation technician 108 (such as a person, installation personnel, user, etc.).

The network environment 100 further includes network 190, communication management resource 140 (a.k.a., configuration management resource), infrastructure management resource 110, prediction engine 120, and storage management resource 160.

The infrastructure management resource 110 has access to corresponding repository 110-R, which stores corresponding data D110. The prediction engine 120 has access to the corresponding repository 120-R, which stores corresponding data D120. The storage management resource 160 has access to the repository 160-R, which stores corresponding data D160.

Further in this example, the communication device 140-1 includes a corresponding display screen that displays the graphical user interface 141. In this example, the user 108 is tasked with the job of installing a new wireless access point in a geographical region 170 as indicated by the proposed wireless network installation plan 150. The proposed wireless network installation plan 150 indicates to install the new wireless access point at a specific location in the geographical region 170.

A combination of the communication management resource 140, communication device 140-1, etc., facilitate configuration of a respective wireless network including a newly proposed wireless access point as discussed herein.

It is noted that the proposed wireless network installation plan 150 can be configured to include location information 155 indicating a location of an original site in which to install a new wireless access point 951.

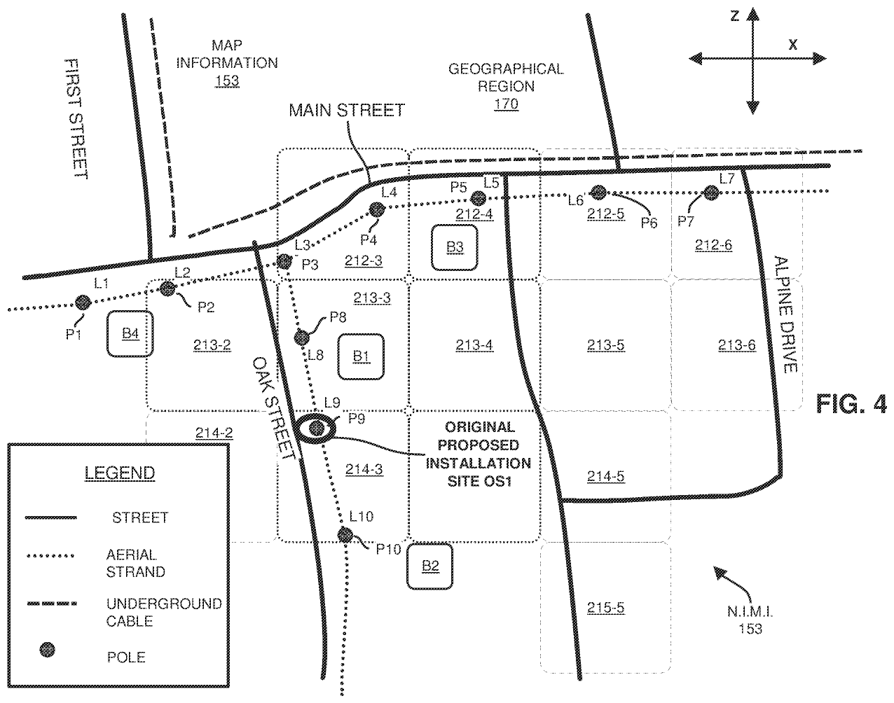

However, prior to installation of the new wireless access point at the original site as specified by the location information 155, the installation technician 108 surveys the geographical region 170. Additionally, note that the installation plan 150 can include map information 153. As its name suggests, the map information 153 includes a top view map of the corresponding geographical region 170 as well as a corresponding marker indicating the proposed location for installing the new wireless access point as specified by the location information 155. The example of the map information 153 is shown in FIG. 4, which will be discussed in detail below.

Referring again to FIG. 1, assume that the installation technician 108 identifies an impediment at the geographical region 170, preventing implementation of the new wireless access point at the location as specified by the location information 155. The following drawings and description present a unique way in which to manage installation of one or more wireless access points in circumstances in which the installation technician 108 has a concern about installing the new wireless access point at the original site (location as specified by the location information 155) in order to provide efficient wireless coverage to user in different geographical regions. In other words, rather than install the new wireless access point at the location as specified by the location information 155 and risk providing poor wireless coverage by the new wireless access point at the original site, the communication device 140-1 communicates with the communication management resource 140 to determine a better location in which to install the new wireless access point in the geographical region 170.

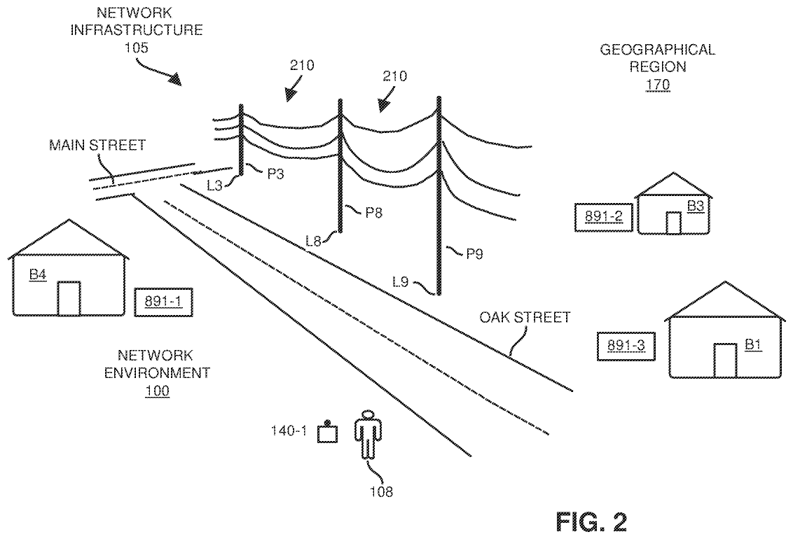

FIG. 2 is an example diagram illustrating a wireless access point installation technician surveying a geographical region as discussed herein.

In this example, as previously discussed, the installation technician 108 is deployed to the geographical region 170 to first inspect the geographical region 174 installation of the new wireless access point. As shown, the geographical region 170 includes network infrastructure 105 such as pole P3 at location L3, pole P8 at location L8, pole P9 at location L9, etc.

The new wireless access point may be deployed to provide wireless services to one or more different subscriber domains such as associated with household 891-1 (also known as building B1), household 891-2 (also known as building B2), household 891-3 (also known as building B3), and so on.

Additionally, the network infrastructure 105 includes wires and/or cables 210 extending between the poles P3, P8, P9, etc. Note that the new wireless access point can be installed in any suitable location in the geographical region 170 such as on the telephone poles, on the wires, etc.

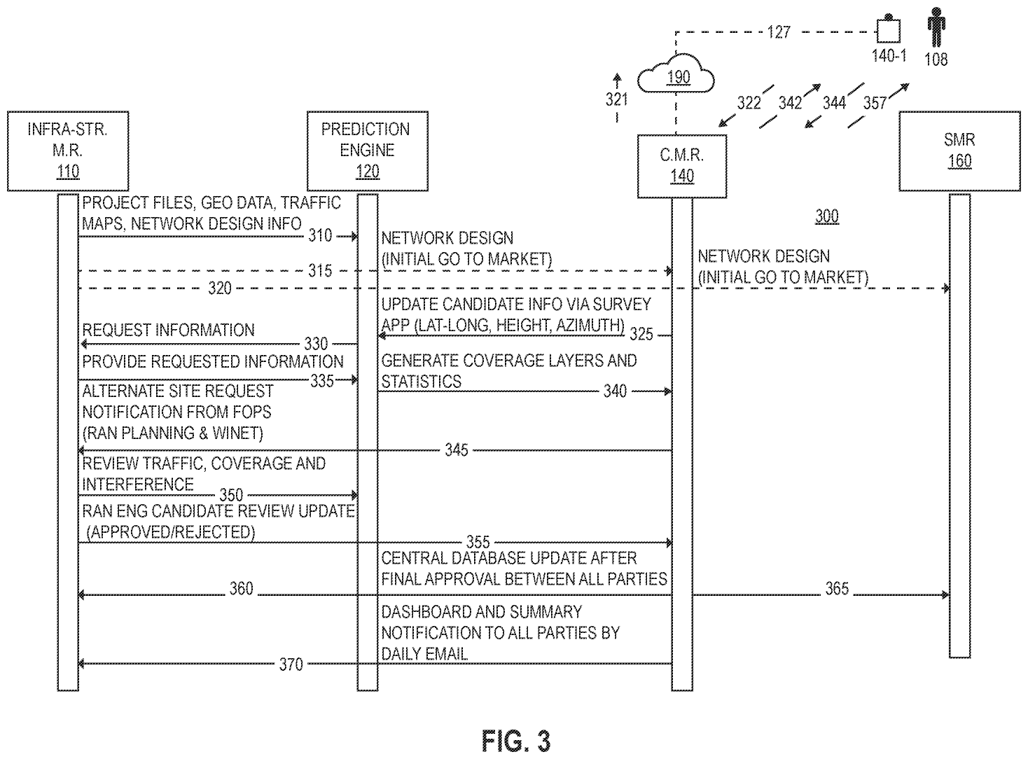

FIG. 3 is an example diagram illustrating a site management system flow of communications and operations facilitating installation of a new wireless access point as discussed herein.

As shown in flowchart 300, via communications 310 from the infrastructure management resource 110 over the network 190 to the prediction engine 120, the infrastructure management resource 110 initially provides information associated with the generation of the installation plan 150 to the prediction engine 120. The prediction engine 120 stores the received information as data D120 in the repository 120-R.

The information transmitted in communications 310 can include any suitable information such as project files, Geo data, traffic maps, network design information, etc., associated with generation of the installation plan 150 for installation of the new wireless access point at the proposed location as indicated by location information 155.

Via communications 315, the infrastructure management resource 110 or other suitable entity transmits the proposed wireless network installation plan 150 over the network 190 to the communication management resource 140.

Via communications 320, the infrastructure management resource 110 or other suitable entity transmits the proposed wireless network installation plan 150 over the network 190 to the communication management resource 140.

Via communications 321, the communication management resource 140 communicates the proposed wireless network installation plan 150 to the communication device 140-1 operated by the installation technician 108. The installation technician 108 operates the communication device 140-1 to display the map information 153 associated with the installation plan 150 on the graphical user interface 141 as shown in FIG. 4. As further discussed herein, via the location information 155, the installation technician 108 is able to identify the original location in which to install the new wireless access point.

FIG. 4 is an example diagram illustrating a proposed location in which to install a corresponding new wireless access point as discussed herein.

Note that the network infrastructure map information 153 as shown in FIG. 4 can be generated based on analysis of any suitable information such as including street view images obtained via a respective image capturing device, land surveys, infrastructure information indicating physical resources such as aerial strands, underground cables, poles, etc., installed in a respective geographical region, and so on.

In this example, the displayed map information 153 indicates subregions such as geographical region 212-3, geographical region 212-4, etc.

For example, as shown, the map information 153 (such as top view) indicates street information as well as subdivisions of regions such as geographical region 211-1, geographical region 212-3, geographical region 212-4, geographical region 212-5, geographical region 212-6, geographical region 213-2, geographical region 213-3, geographical region 213-4, geographical region 213-5, geographical region 213-6, geographical region 214-2, geographical region 214-3, geographical region 214-4, geographical region 214-5, geographical region 215-5, etc.

Note that although the regions associated with the network infrastructure map information 120-1 are subdivided into square partitions in this non-limiting example embodiment, each of the geographical regions can be of any suitable shape such as octagon, circle, etc.

In addition to subdivided regions, the displayed map information 153 can be configured to include a map of network resources (physical infrastructure or installed physical assets such as aerial strands, underground cables, telephone poles, etc.) that are available to facilitate installation of a respective new wireless access point in those subregions. As its name suggests, the map information 153 indicates locations of the different available resources with respect to existing roads, buildings, etc.

More specifically, based on analysis of available information, and after appropriate analysis of images, surveys, etc., the map information 153 is produced to indicate that: telephone pole P1 (installed physical asset) is located at location L1; telephone pole P2 (installed physical asset) is located at location L2; telephone pole P3 (installed physical asset) is located at location L3; telephone pole P4 (installed physical asset) is located at location L4; telephone pole P5 (installed physical asset) is located at location L5; telephone pole P6 (installed physical asset) is located at location L6; telephone pole P7 (installed physical asset) is located at location L7; telephone pole P8 (installed physical asset) is located at location L8; telephone pole P9 (installed physical asset) is located at location L9; telephone pole P10 (installed physical asset) is located at location L10; and so on.

Map information 153 in this example further illustrates that: a first aerial strand (installed physical asset such as above ground communication links such as coax, fiber, twisted pair of wires, etc.) extends between the telephone pole P1 and telephone pole P2; a third aerial strand (installed physical asset such as above ground communication links such as coax, fiber, twisted pair of wires, etc.) extends between the telephone pole P3 and telephone pole P4; a fourth aerial strand (installed physical asset such as above ground communication links such as coax, fiber, twisted pair of wires, etc.) extends between the telephone pole P4 and telephone pole P5; a fifth aerial strand (installed physical asset such as above ground communication links such as coax, fiber, twisted pair of wires, etc.) extends between the telephone pole P5 and telephone pole P6; and so on.

Note further that a same solution as discussed herein can be applied in a macro/micro or Het-net cellular deployment, where base stations/antennae/radio mounting may be over a building rooftop/towers/poles/bill-boards or any such structures.

Note that each of the aerial strands supports conveyance of the bidirectional communication signals, power signals, etc., supporting connectivity of respective wireless access points.

In accordance with further examples, map information 153 can be configured to indicate which of the one or more multiple subregions are to be provided wireless service by the newly installed wireless access point. For example, the map information 153 can indicate that it is desirable to provide wireless connectivity/services to one or more of geographical regions 212-3, 212-4, 213-2, 213-3, 213-4, 214-2, 214-3, and 214-4. This gives the installation technician 108 an idea where it may be best to install a corresponding new wireless access point.

Yet further, as previously discussed, techniques herein include the installation technician 108 discovering that some of the geographical regions and corresponding physical infrastructure residing in network environment 100 may or may not be good candidates to install a respective new wireless access point.

For example, the map information 153 indicates that the installation technician 108 should, if possible, install the new wireless access point at the location L9 on or near pole P9 as specified by the location information 155. Note that the location information 155 can further indicate a height on the pole P9 at location L9 in which to install the new wireless access point.

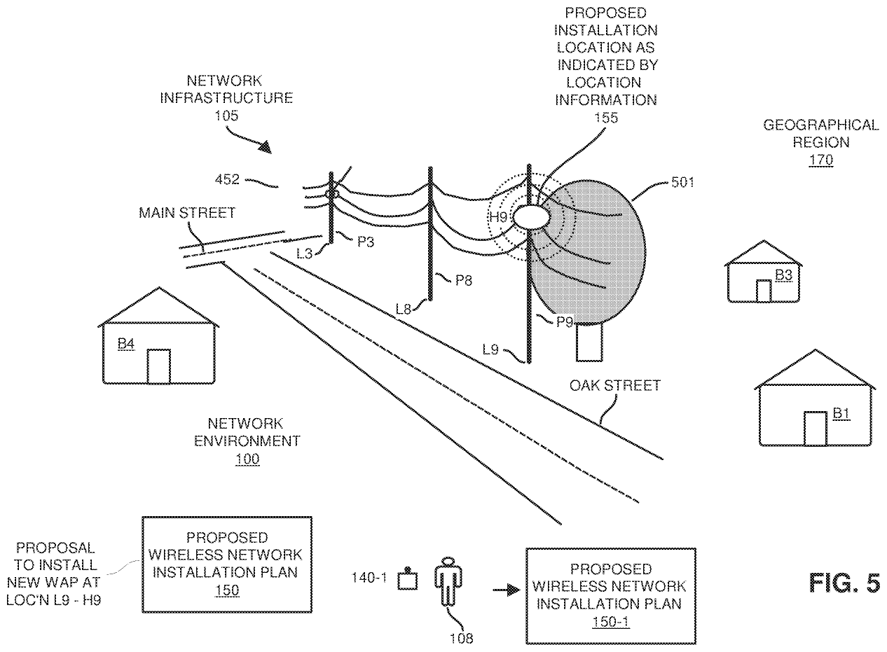

See FIG. 5 for a view of the proposed location in which to install the wireless access point as indicated by the location information 155.

In this example, assume that the installation technician 108 determines that installation of the new wireless access point at the location L9 (such as original proposed installation site OS1) is not feasible for any reason such as: the pole P9 no longer exists at location L9, there is a physical barrier such as a tree or other entity 501 (FIG. 5) in a vicinity of the location L9 that will prevent the new wireless access point from providing good wireless coverage to any of the subscribers for buildings B1, B2, B3, B4, etc., in the nearby area.

Accordingly, in this example, assume that the visit by the installation technician 108 to the geographical region 170 reveals the entity 501 as being an impediment to installing the new wireless access point at the original proposed location as specified by the location information 155.

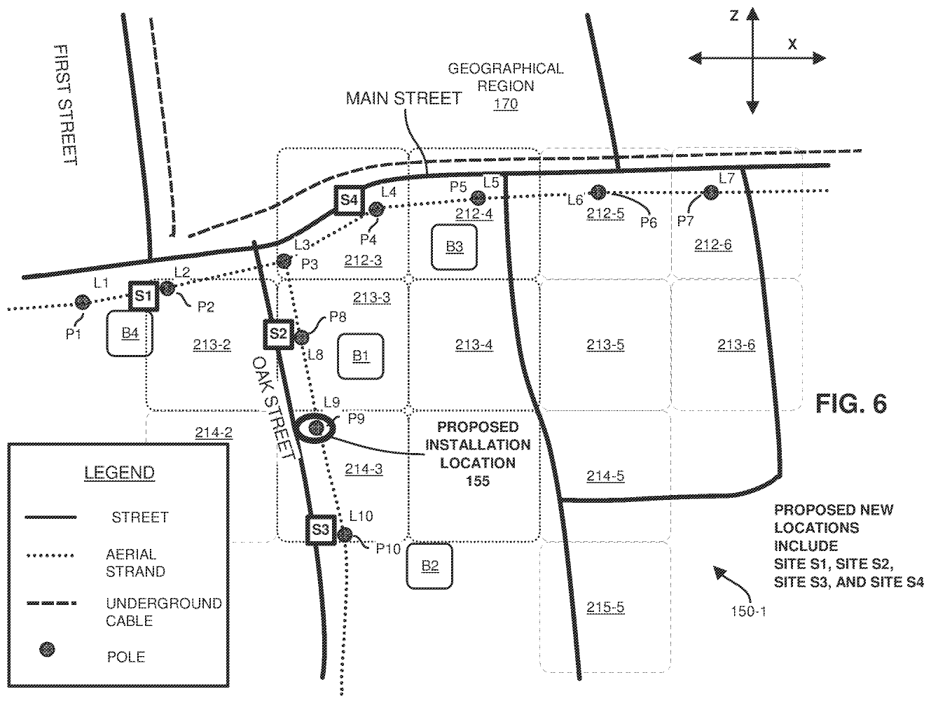

FIG. 6 is an example diagram illustrating input from a respective installation technician specifying multiple alternative propose locations in which to intentionally install a wireless access point as discussed herein.

After a survey of the geographical region 170, the installation technician 108 visually notes that the alternative site S1, alternative site S2, alternative site S3, and alternative site S4, each might be able to provide desired wireless coverage to the geographical region 170 as an alternative to installation of the new wireless access point at the location L9 specified by the location information 155.

In such an instance, the installation technician updates the proposed installation plan 150 to produce updated installation plan 150-1. The updated installation plan 150-1 (such as a modification of the original installation plan 150) includes markings indicating the alternative site S1, alternative site S2, alternative site S3, and alternative site S4.

More specifically, the installation technician 108 proposes possible installation of the new wireless access point at the alternative site S1 or location L2; the installation technician 108 proposes possible installation of the new wireless access point at the alternative site S2 or location L8; the installation technician 108 proposes possible installation of the new wireless access point at the alternative site S3 or location L10; the installation technician 108 proposes possible installation of the new wireless access point at the alternative site S4 or location L4.

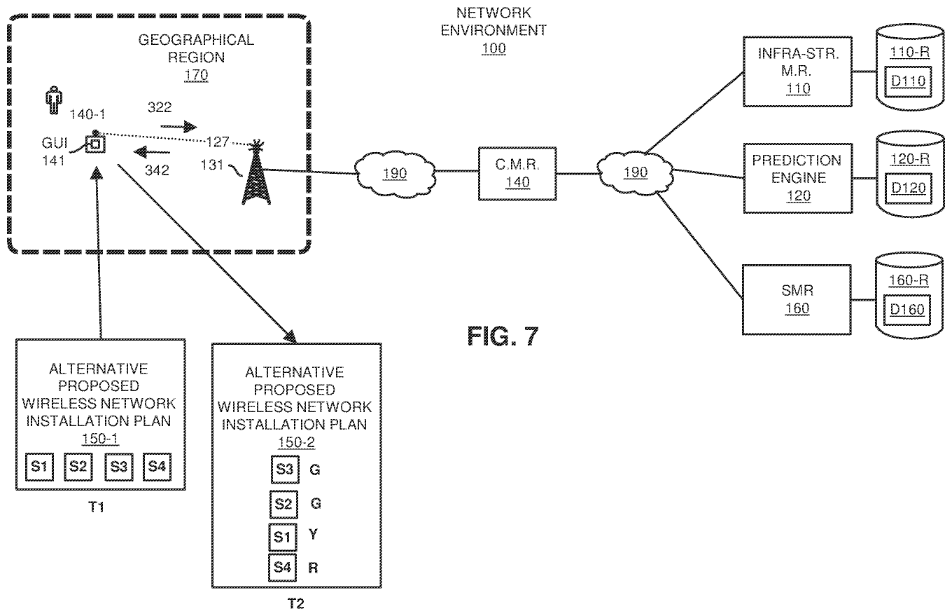

FIG. 7 is an example diagram illustrating communication of the multiple alternative propose installation sites and corresponding ranking of the proposed installation sites as discussed herein.

In this example, at or around time T1, via communications 322, the installation technician 108 operating the communication device 140-1 transmits the updated installation plan 150-1 including the proposed alternative sites S1, S2, S3, S4 to the communication management resource 140.

Referring again to FIG. 3, via communications 325, the communication management resource 140 initiates a preliminary review of each of the proposed alternative sites in which to install the new wireless access point. For example, via communications 325, the preliminary review of the newly proposed alternative sites includes the communication management resource 140 transmitting the alternative proposed wireless network installation plan 150-1 (such as modified map information) and/or updated proposed alternative sites (including alternative site S1, alternative site S2, alternative site S3, alternative site S4, etc.) over the network 190 to the prediction engine 120.

Note that the communications 325 can include any suitable information such as the modified map information 150-1 indicating the physical locations of the different alternative sites as proposed by the installation technician 108 or other suitable entity. Thus, in one example, the communications 325 in this example can be configured to include an update of the original installation plan 150-1 generated via a survey application executed on the communication device 140-1. As previously discussed, the survey application executed on the communication device 140-1 enables the respective user 108 to specify the precise locations of each of the alternative sites S1, S2, S3, S4, etc., as well as the corresponding height associated with the proposed installation of an azimuth for each of the proposed sites.

In response to receiving the communications 325, the prediction engine 120 further initiates a preliminary review of the proposed alternative sites as indicated by the installation technician 108. To perform the preliminary review, the prediction engine 120 transmits communications 330 requesting any suitable information from the infrastructure management resource 110 to perform the wireless coverage analysis for each of the different alternative sites associated with the geographical region 170.

Via communications 335, the infrastructure management resource 110 provides the requested information needed for the prediction engine 120 to perform a preliminary analysis of wireless coverage that would be provided by a new wireless access point installed in each of the different sites (i.e., alternative site S1, alternative site S2, alternative site S3, an alternative site S4) proposed by the installation technician 108.

The prediction engine 120 utilizes the requested information as well as the alternative site information to determine coverage layers and statistics, such as via wireless coverage simulations, associated with installation of the new wireless access point at each of the proposed alternative locations (S1, S2, S3, S4). Subsequently, via communications 340 from the prediction engine 120, the communication management resource 140 is notified of the different wireless coverages and/or performance or quality of wireless coverage that would be provided by the new wireless access point at each of the proposed alternative locations.

The communication management resource 140 or other suitable entity as discussed herein processes the received information from the prediction engine 120 and corresponding preliminary analysis of the different installations. Based on the processing of the received information associated with the preliminary analysis, the communication management resource or other suitable entity 140 generates corresponding performance metrics such as: i) a first performance metric Y indicating the quality of anticipated wireless coverage that would be provided by the new wireless access point if install that the alternative site S1, ii) a second performance metric G indicating the quality of anticipated wireless coverage that would be provided by the new wireless access point installed at the alternative site S2, iii) a third performance metric G indicating the quality of anticipated wireless coverage that would be provided by the new wireless access point installed at the alternative site S3, iv) a fourth performance metric R indicating the quality of anticipated wireless coverage that would be provided by the new wireless access point if install that the alternative site S4.

As previously discussed, each of the performance metrics as discussed herein can be generated to indicate the degree to which the proposed installation of the new wireless access point at the corresponding site will provide desired wireless services to communication devices in the geographical region 170 serviced by the new wireless access point. The higher performance metric such as assigned a value of G or other suitable metric indicates that the proposed alternative site in theory should provide excellent wireless coverage in the geographical region and support high-bandwidth wireless communications; the moderate performance metric such as assigned a value of Y or other suitable metric indicates that the proposed alternative site in theory should provide moderately good wireless coverage in the geographical region and support moderate-bandwidth wireless communications; the lowest performance metric such as assigned a value of R or other suitable metric indicates that the proposed alternative site in theory most likely would provide poor or unacceptable wireless coverage in the geographical region and support low-bandwidth wireless communications.

Note that any grading and/or ranking can be used to produce the different performance metrics.

Referring again to FIG. 7, at or around time T2, via communications 342, the communication management resource 140 transmits performance information associated with the preliminary analysis of each of the proposed alternative sites S1, S2, S3, S4, etc., to the installation technician 108 operating the communication device 140-1.

In this example, based on the preliminary analysis, the communication management resource 140 notifies the installation technician 108 operating the communication device 140-1 that the alternative site S3 is ranked highest amongst all the proposed alternative sites and is assigned a value G (green) indicating that installation of the new wireless access point at the site S3 likely would provide good wireless coverage in the geographical region 170.

Based on the preliminary analysis, the communication management resource 140 notifies the installation technician 108 operating the communication device 140-1 that the alternative site S2 is ranked next highest amongst all the proposed alternative sites and is assigned a value G (green) indicating that installation of the new wireless access point at the site S3 likely would provide good wireless coverage in the geographical region 170.

Based on the preliminary analysis, the communication management resource 140 notifies the installation technician 108 operating the communication device 140-1 that the alternative site S1 is ranked next highest amongst all the proposed alternative sites and is assigned a value Y (yellow) indicating that installation of the new wireless access point at the site S3 likely would provide only a moderate quality of wireless coverage in the geographical region 170.

The communication management resource 140 notifies the installation technician 108 operating the communication device 140-1 that the alternative site S4 is ranked lowest amongst all the proposed alternative sites and is assigned a value R (red) indicating that installation of the new wireless access point at the site S4 likely would provide poor wireless coverage in the geographical region 170.

Thus, the performance information and corresponding ranking associated with each of the sites provides the installation technician 108 idea of which proposed alternative sites are likely best in which to install a respective wireless access point.

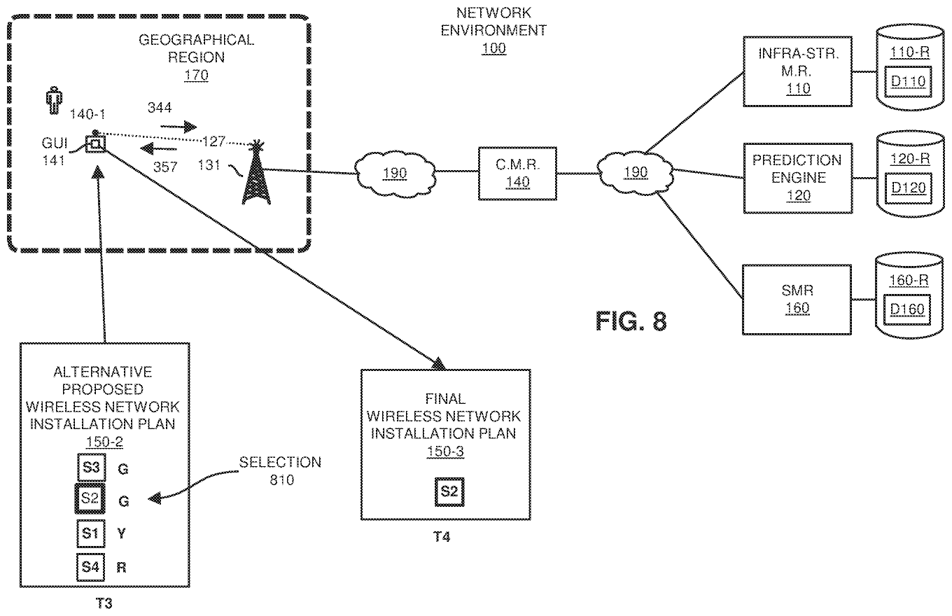

FIG. 8 is an example diagram illustrating communication of a selected installation site from an alternative site ranking and receipt of a final wireless network installation plan as discussed herein.

Note that while this analysis being performed, the installation technician 108 may continue to survey the geographical region 170. During the additional survey, the installation technician 108 may determine that proposed site S3 is not necessarily a good site because of an originally overlooked impediment to install it at that location.

Thus, in this example, the installation technician 108 selects the alternative site S2 installation of the new wireless access point. Note that the installation technician 108 may further confirm with one or more entities in the network environment 100 that it is acceptable to go forward with installation of the new wireless access point at the proposed alternative location S2. More specifically, this may include the installation technician 108 communicating the selected alternative site S2 in the communications 344 over the wireless communication link 127 and through network 190 to the communication management resource 140. Accordingly, the communication management resource 140 is apprised of the selected alternative site S2 via communications 344.

Referring again to FIG. 3, prior to installation of the new wireless access point at the selected and preliminary tested alternative site S2, the communication management resource 140 performs a secondary check (secondary analysis) with the infrastructure management resource 110 to determine whether the installation technician 108 should proceed with installation of the new wireless access point at the alternative site S2.

More specifically, via communications 345, the communication management resource 140 provides notification of the alternate site request (i.e., installation of the new wireless access point at the alternate site S2) to the infrastructure management resource 110.

In response to receiving the notification in communications 345, the infrastructure management resource 110 communicates with the prediction engine 120 via communications 350. The communications 350 support review of traffic, coverage, and interference associated with implementing the new wireless access point at the proposed alternative site S2 in view of other wireless access points already installed and implemented at or near the geographical region 170. Based on such information, the infrastructure management resource 110 generates a respective decision whether or not to allow the installation technician 110 to install the new wireless access point at the alternative site S2.

Via communications 355, the infrastructure management resource 110 provides notification of approval or rejection of the proposed installation at the alternative site S2.

Thus, in one example, the final decision of whether to allow installation of the new wireless access point at the finally selected alternative site S2 includes the communication management resource 140 or other suitable entity in the network environment 100 receiving notification of the final selection of the alternative site S2. In response to receiving the message indicating final selection of the alternative site S2 by the installation technician, the system as described herein includes performing a secondary analysis of installing the first wireless access point at the alternative site, the secondary analysis being more robust than the preliminary analysis. Based on the secondary analysis, predicting a quality of wireless services associated with installation of the first wireless access point at the alternative site S2 as indicated by the installation technician selection. The communication management resource 140 or other suitable entity generates a decision approving installation of the first wireless access point at the alternative site in response to detecting that the predicted quality (such as power or signal quality, size of wireless coverage, etc.) of wireless services is above a threshold level.

In this example, as previously discussed assume that the infrastructure management resource 110 performs the secondary analysis (which is more robust than the preliminary analysis as previously discussed) and approves installation of the new wireless access point at the alternative site as to because it is determined to likely provide good wireless coverage above a threshold level in that region without causing undue interference to other wireless access points and/or wireless stations operating in the region. Thus, in this example, the communication management resource 140 receives approval of installing the new wireless access point at the alternative site as to via communications 355 received from the infrastructure management resource 110.

Referring again to FIG. 8, in response to receiving the approval, via communications 357 communicated at or around time T4, the communication management resource 140 communicates the final wireless network installation plan 150-3 to the installation technician 108. In this example, the final wireless network installation plan 150-3 notifies the installation technician 108 to install the new wireless access point at the alternative location S2.

Referring again to FIG. 3, as a further response to receiving communications 355 indicating acceptance of installing the new wireless access point at the alternative site S2, via communications 360, the communication management resource 140 notifies the infrastructure management resource 110 that the new wireless access point is being installed or has been installed at the alternative site S2 in the geographical region 170.

Yet further, via communications 365, the communication management resource 140 provides notification of the final wireless network installation plan 150-3 and corresponding installation of the wireless access point at the alternative site S2 to the storage management resource 150. In such an instance, via communications 360 and communications 365, each of the one or more entities in the network environment 100 are updated to keep track of installation of the new wireless access point at the alternative site S2.

If desired, via communications 370 from the communication management resource 140 or other suitable entity, the infrastructure management resource 110 and corresponding team of people are notified of the newly installed wireless access point. The communications 370 can include dashboard summary notification to all parties via email or other suitable method of transmitting communications.

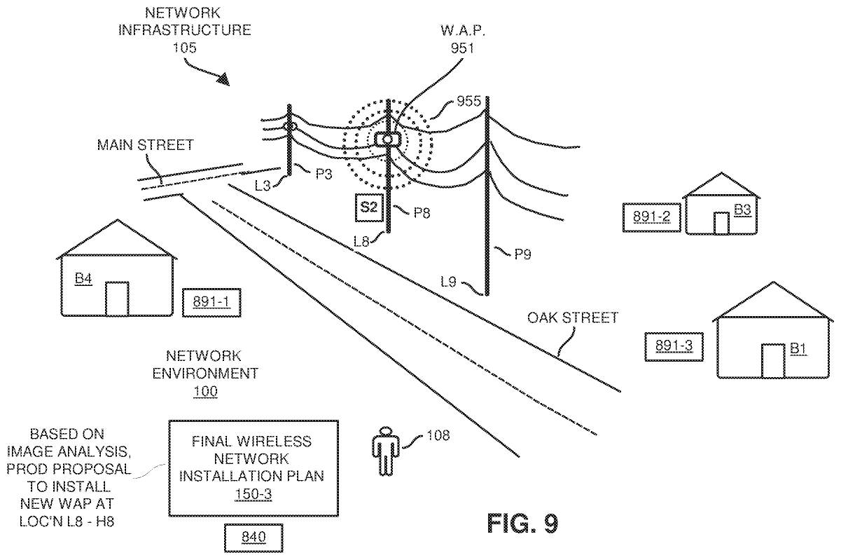

FIG. 9 is an example diagram illustrating installation of the wireless access point at the selected installation site as discussed herein.

The alternative site S2 (also known as location L8 and corresponding pole P8 at height H8) in FIG. 9 illustrates installation of the new wireless access point 951 at a height H8.

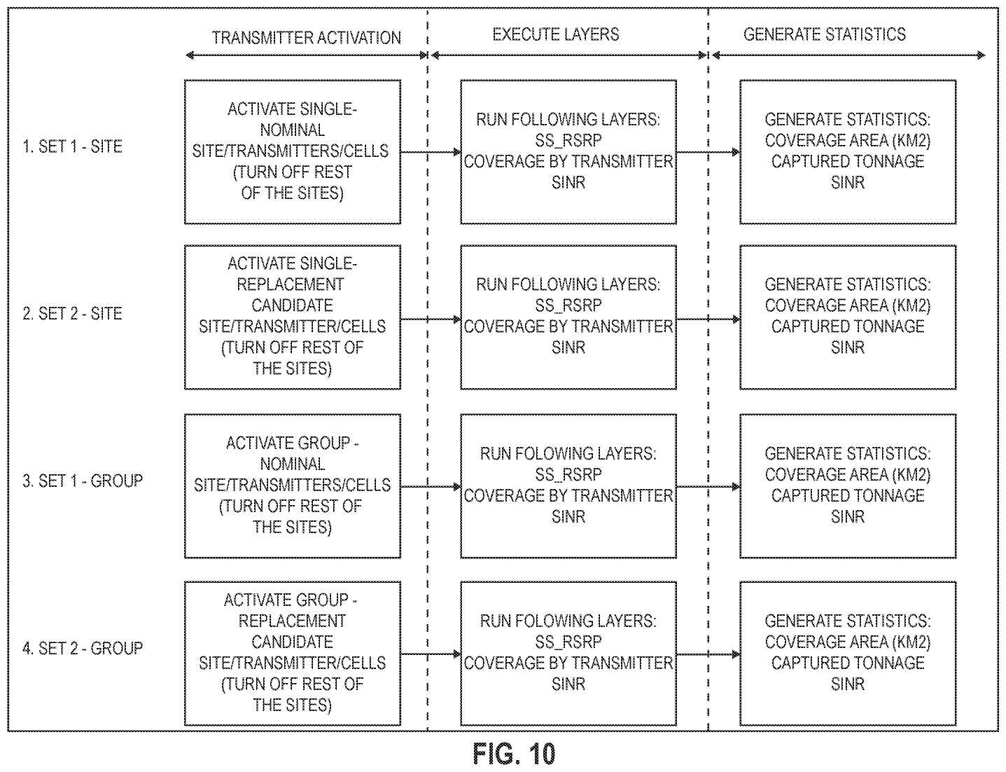

FIG. 10 is an example diagram illustrating an example prediction layer generation workflow as discussed herein.

In this example, one or more analyzers such as the prediction engine 120, infrastructure management resource 110, etc., performs analysis of installing the new wireless access point 951 at different layers based on parameters such as RSRP (Reference Signals Received Power), SINR (Signal-to-Noise-Plus-Interference Ratio), etc.

Based on the analysis, the one or more analyzes produce statistical information such as wireless coverage area anticipated be provided by the newly installed wireless access point in each of the different proposed locations, tonnage information, SINR, etc.

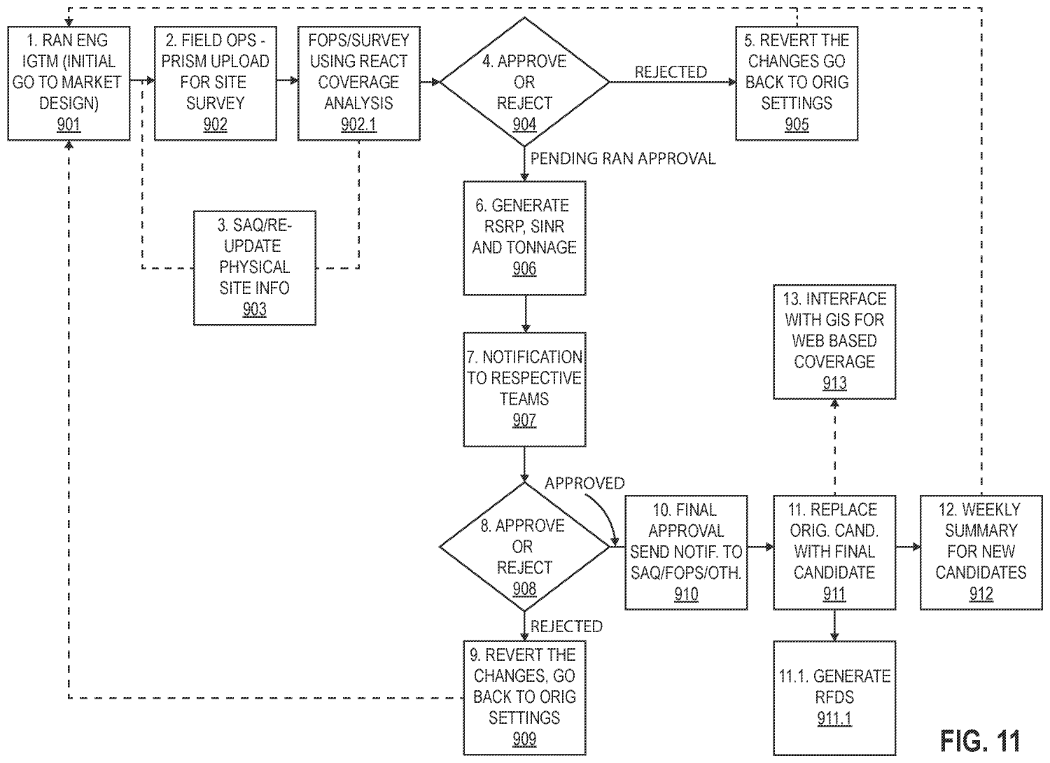

FIG. 11 is an example diagram illustrating an RF design automation workflow as discussed herein.

Flowchart 1100 and FIG. 11 is another way to view the operations of managing installation of wireless access points as previously discussed.

In operation 901, the system (such as one or more or combination of the infrastructure management resource 110, prediction engine 120, communication management resource 140, storage management resource 160, communication device 140-1, etc.) as described herein produces a proposed installation plan 150 including information such as a location L9, H9 and corresponding azimuth angle information at which to install a corresponding new wireless access point 951.

In operation 902, the installation technician 108 surveys the corresponding geographical region 170 and proposes one or more alternative sites in which to potentially install the corresponding new wireless access point because it is not feasible to install the new wireless access point at the original proposed location as specified by the location information 155.

In processing operation 902.1, the system performs a preliminary wireless coverage analysis associated with each of the proposed new locations S1, S2, S3, S4, etc.

In processing operation 903, the system updates the physical site information such as by running RSRP and tonnage analysis for the site and group. In other words, the system updates the site information associated with the proposed installation of the new wireless access point for the proposed possible candidate locations in terms of site and group analysis (see other FIG. 10).
For Replacement candidates use _r1 or _r2
after RAN Design Site ID
Turn off main RAN Design Site ID and use replaced candidate for coverage and tonnage calc
At one point only one replacement will be
active for cluster and site coverages
FOPS may update Azimuth, Height or location of the site

In operation 904, the system such as communication device operated by installation personnel and the corresponding application in the network approves or rejects the one or more proposed alternate sites. If a reject condition, then execute operation 905 to revert back to the original design.

In operation 904 or operation 906, the technician is notified of the different grades (such as red, yellow, green) assigned to each of the possible candidate locations.

In operation 906, the field technician 108 selects a particular candidate from the yellow, green, red options. Hopefully, the field technician selects amongst the green option, most likely to provide the best chance of installation a good wireless coverage. This final selection option of installing the wireless access point is further rigorously tested before the installation technician 108 (installation personnel) is notified to install the new wireless access point at the corresponding particular selected candidate location (such as site S2 in this case).
Coverage Area and Percentage of covered area (Site and Group)
Tonnage Captured and Percentage of Captured Tonnage (Site and Group)
RSRP and SINR or any other coverage layer threshold should be modifiable by RF Team
RF team should be able to update RF parameters
RF team should be able to run any cell, sites, cluster or network layers and generate statistics by selection

In processing operation 907, the system performs a more rigorous wireless coverage in interference analysis of installing the new wireless access point at the site S2. Additionally, the system provides notification to teams including dashboard summary.

In processing operation 908, based on RSRP for the site in that cluster level (such as the analysis of the new wireless access point at the site S2 with respect to the existing wireless access points are installed and operating in the corresponding geographical region 170), the system provides notification of whether the final selected candidate location (site S2) will provide the appropriate wireless coverage and services at the selected location. If the finally selected site is approved, system flow continues at processing operation 910.
RF Engineer should be able to Visualize SS_RSRP
and SINR over a Map
RF Engineer should be able to review statistics
table (Cell, site, Coverage area, SINR area and tonnage)

Alternatively, if the finally selected site S2 is rejected, then system flow continues at processing operation 909.

In processing operation 909, in response to detecting the rejection of installing the new wireless access point at the selected site S2 at operation 908, the system as discussed herein reverts the changes and goes back to the original proposed installation plan 150. The system saves any history of records and sends notifications accordingly.

In processing operation 910, in response to detecting the approval of installing the new wireless access point at the finally selected site S2 in operation 908, the system generates a final approval and sends notification of the selected installation site S2 to other entities in the network environment 100.
Turn off main RAN Design Site ID and use replaced
site for coverage and sinr calc
Keep Track Record of Comments or any other changes
Use this Candidate for all other next steps

In processing operation 911, storage management resource or other suitable entity replaces the original site candidates with the finally approved candidate and corresponding updated details.

In processing operation 911.1, system generates an RFDS such as selected fields exported of cell, transmitter and site table.

In processing operation 912, the system generates weekly summary for new candidates, pending for field operation review, RF review, etc. The master project is updated including any notifications and changes.

In processing operation 913, the system interfaces with one or more entities to perform a web-based export of the covered flares associated with the new wireless access point.

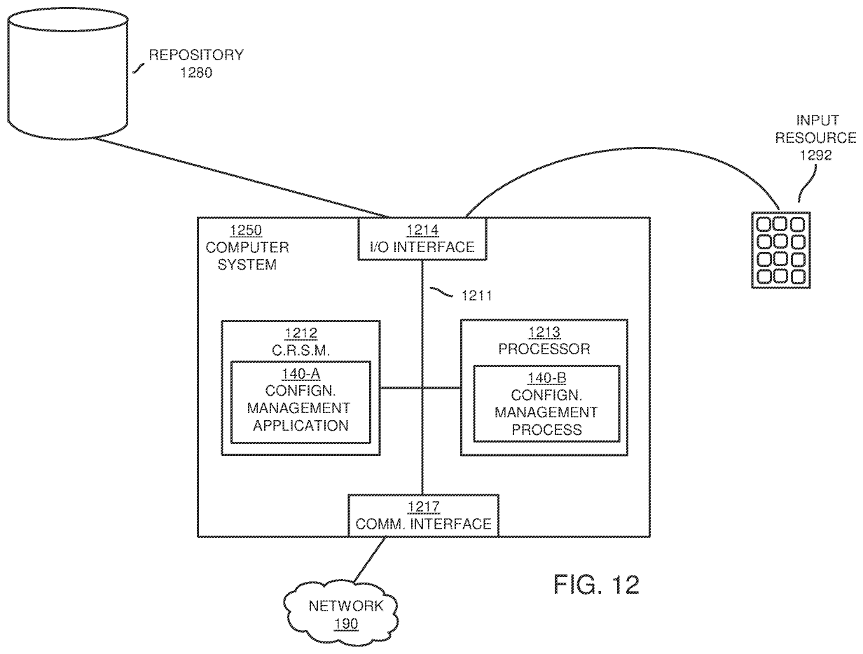

FIG. 12 is an example block diagram of a computer system for implementing any of the operations as previously discussed according to embodiments herein.

Note that any of the resources (such as infrastructure management resource 110, prediction engine 120, communication management resource 140, storage management resource 160, communication device 140-1, etc.) as discussed herein can be configured to include computer processor hardware and/or corresponding executable instructions to carry out the different operations as discussed herein.

For example, as shown, computer system 1250 of the present example includes interconnect 1211 coupling computer readable storage media 1212 such as a non-transitory type of media (which can be any suitable type of hardware storage medium in which digital information can be stored and or retrieved), a processor 1213 (computer processor hardware), I/O interface 1214, and a communications interface 1217.

I/O interface(s) 1214 supports connectivity to repository 1280 and input resource 1292.

Computer readable storage medium 1212 can be any hardware storage device such as memory, optical storage, hard drive, floppy disk, etc. In one embodiment, the computer readable storage medium 1212 is computer readable storage hardware that stores instructions and/or data.

As shown, computer readable storage media 1212 can be encoded with management application 140-A (e.g., including instructions) in a respective wireless station to carry out any of the operations as discussed herein.

During operation of one embodiment, processor 1213 accesses computer readable storage media 1212 via the use of interconnect 1211 in order to launch, run, execute, interpret or otherwise perform the instructions in management application 140-1 stored on computer readable storage medium 1212. Execution of the management application 140-A produces management process 140-B to carry out any of the operations and/or processes as discussed herein.

Those skilled in the art will understand that the computer system 1250 can include other processes and/or software and hardware components, such as an operating system that controls allocation and use of hardware resources to execute the management application 140-A.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1250 may reside at any location or can be included in any suitable resource in any network environment to implement functionality as discussed herein.

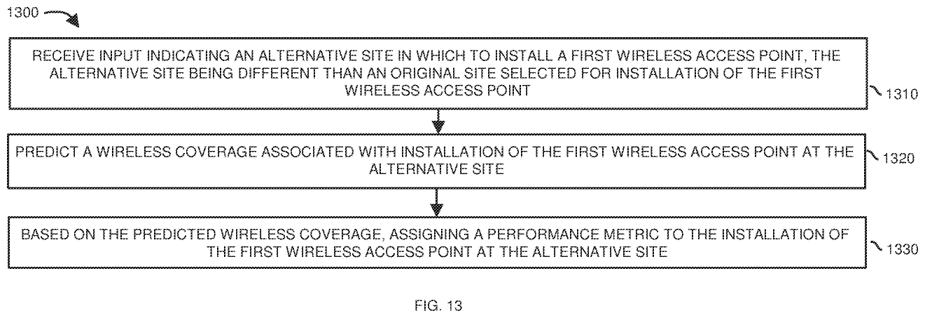

Functionality supported by the different resources will now be discussed via flowcharts in FIG. 13-15. Note that the steps in the flowcharts below can be executed in any suitable order.

FIG. 13 is a flowchart 1300 illustrating an example method according to embodiments herein. Note that there will be some overlap with respect to concepts as discussed above.

In processing operation 1310, one or more entities such as the communication management resource 140 receives input indicating an alternative site in which to install a first wireless access point. The alternative site is different than an original site selected for installation of the first wireless access point.

In processing operation 1320, the one or more entities predicts a wireless coverage associated with installation of the first wireless access point at the alternative site.

In processing operation 1330, based on the predicted wireless coverage, the system assigns a performance metric to the installation of the first wireless access point at the alternative site.

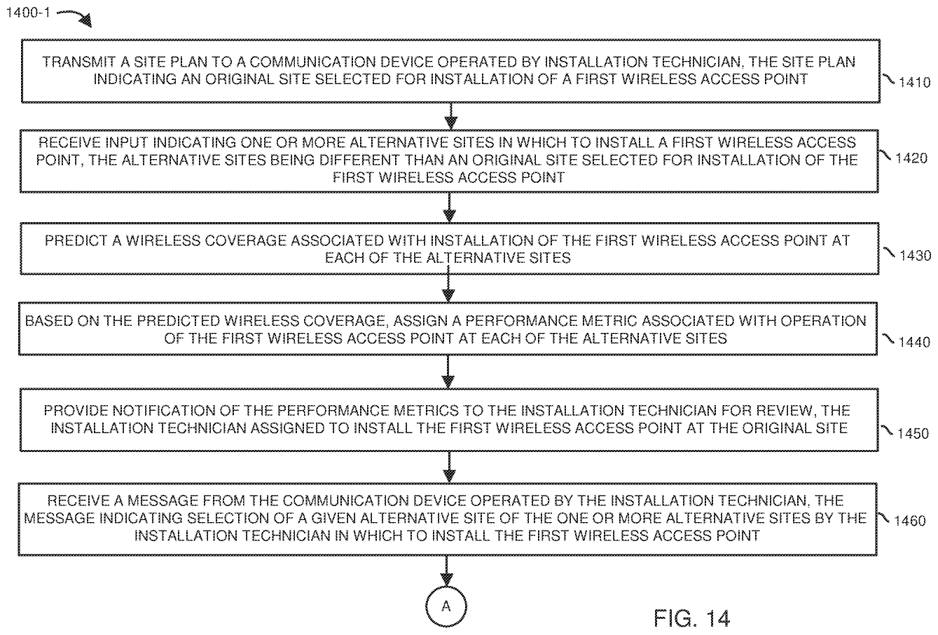

FIG. 14 is a flowchart 1400 illustrating example methods according to embodiments herein. Note that there will be some overlap with respect to concepts as discussed above.

In processing operation 1410, the system transmits a site plan to a communication device operated by the installation technician. The site plan indicates an original site selected for installation of a first wireless access point.

In processing operation 1420, the system receives input indicating one or more alternative sites in which to install a first wireless access point. The alternative proposed sites such as sites S1, S2, S3, S4, etc., are different than an original site selected for installation of the first wireless access point.

In processing operation 1430, via preliminary analysis, the system predicts a wireless coverage associated with installation of the first wireless access point at each of the proposed alternative sites.

In processing operation 1440, based on the predicted wireless coverage associated with installing the wireless access point at the different proposed sites, the system assigns a performance metric associated with operation of the first wireless access point at each of the proposed alternative sites.

In processing operation 1450, the system provides notification of the performance metrics to the installation technician for review. The installation technician is assigned to install the first wireless access point at the original site.

In processing operation 1460, the system receives a message from the communication device operated by the installation technician. The message indicates selection of a given alternative site of the one or more alternative sites by the installation technician in which to install the first wireless access point.

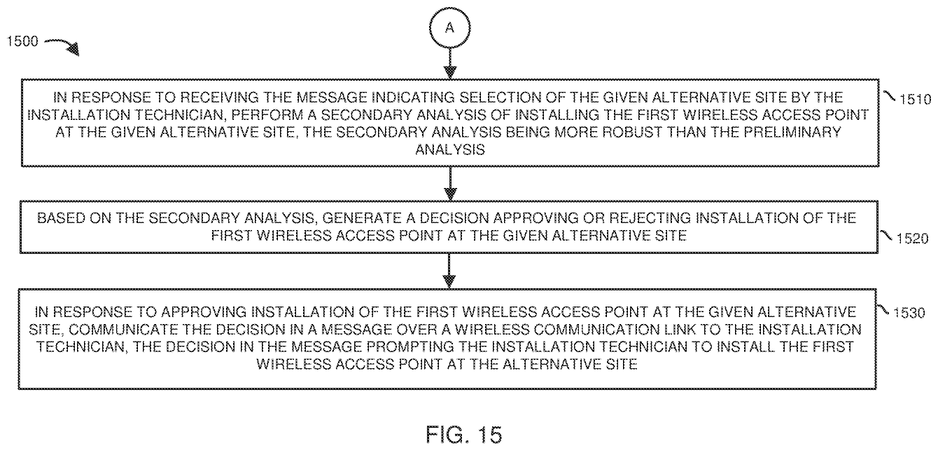

In processing operation 1470 in FIG. 15, in response to receiving the message indicating selection of the given alternative site by the installation technician, the system performs a secondary analysis of installing the first wireless access point at the given alternative site S2. As previously discussed, the secondary analysis may be much more robust and take longer to generate than the preliminary analysis.

In processing operation 1480, based on the secondary analysis, the system generates a decision approving or rejecting installation of the first wireless access point at the given alternative site S2.

In processing operation 1490, in response to approving installation of the first wireless access point at the given alternative site, the system communicates the decision in a message over a wireless communication link to the installation technician. The decision in the message prompts the installation technician to install the first wireless access point at the alternative site.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
receiving input indicating an alternative site in which to install a first wireless access point, the alternative site being different than an original site selected for installation of the first wireless access point;
predicting a wireless coverage associated with installation of the first wireless access point at the alternative site; and
based on the predicted wireless coverage, assigning a performance metric to the alternative site.

2. The method as in claim 1 further comprising:
wirelessly transmitting the performance metric to an installation technician for review.

3. The method as in claim 1, wherein the input indicating the alternative site is generated by a respective installation technician surveying the original site.

4. The method as in claim 3, wherein the respective installation technician generates the input in response to detecting an impediment associated with installation of the first wireless access point at the original site.

5. The method as in claim 3, wherein the respective installation technician generates the input indicating the alternative site based upon an in-person survey by the respective installation technician in a geographical region including the original site.

6. The method as in claim 1 further comprising:
in response to detecting that the performance metric is below a threshold level, rejecting installation of the first wireless access point at the alternative site; and
providing notification of the rejection to a respective installation technician.

7. The method as in claim 1, wherein predicting the wireless coverage associated with the installation of the first wireless access point at the alternative site includes:
performing a preliminary analysis of the first wireless access point providing the predicted wireless coverage at the alternative site; and
producing the performance metric based on the preliminary analysis.

8. The method as in claim 7 further comprising:
providing notification of the performance metric to an installation technician for review, the installation technician assigned to install the first wireless access point at the original site; and
in response to providing notification, receiving a message indicating selection of the alternative site by the installation technician in which to install the first wireless access point.

9. The method as in claim 8 further comprising:
in response to receiving the message indicating selection of the alternative site by the installation technician, performing a secondary analysis of installing the first wireless access point at the alternative site, the secondary analysis being more robust than the preliminary analysis;
based on the secondary analysis, predicting a quality of wireless services associated with installation of the first wireless access point at the alternative site as indicated by the selection; and
generating a decision approving installation of the first wireless access point at the alternative site in response to detecting that the predicted quality of wireless services is above a threshold level.

10. The method as in claim 9 further comprising:
communicating the decision in a message over a wireless communication link to the installation technician, the decision in the message prompting the installation technician to install the first wireless access point at the alternative site.

11. The method as in claim 1, wherein the alternative site is a first alternative site; and
wherein the wireless coverage is a first wireless coverage;
wherein the performance metric is a first performance metric; and
wherein the input further indicates a second alternative site in which to install the first wireless access point, the second alternative site being different than the original site selected for installation of the first wireless access point.

12. The method as in claim 11 further comprising:
predicting second wireless coverage associated with installation of the first wireless access point at the second alternative site; and
based on the predicted second wireless coverage, assigning a second performance metric to the installation of the first wireless access point at the second alternative site.

13. The method as in claim 12 further comprising:
wirelessly communicating the first performance metric and the second performance metric to a technician assigned to installation of the first wireless access point.

14. The method as in claim 13, wherein the first performance metric indicates a first ranking of installing the first wireless access point at the first alternative site;
wherein the second performance metric indicates a second ranking installing the first wireless access point at the second alternative site; and
wherein the second ranking is higher than the first ranking.

15. A system comprising:
communication management hardware operative to:
receive input indicating an alternative site in which to install a first wireless access point, the alternative site being different than an original site selected for installation of the first wireless access point;
predict a wireless coverage associated with installation of the first wireless access point at the alternative site; and
based on the predicted wireless coverage, assign a performance metric to the alternative site.

16. The system as in claim 15, wherein the communication management hardware is further operative to:
wirelessly transmitting the performance metric to an installation technician for review.

17. The system as in claim 15, wherein the input indicating the alternative site is generated by a respective installation technician surveying the original site.

18. The system as in claim 17, wherein the respective installation technician generates the input in response to detecting a deficiency associated with installation of the first wireless access point at the original site.

19. The system as in claim 17, wherein the respective installation technician generates the input indicating the alternative site based upon an in-person survey by the respective installation technician in a geographical region including the original site.

20. The system as in claim 15, wherein the communication management hardware is further operative to:
in response to detecting that the performance metric is below a threshold level, reject installation of the first wireless access point at the alternative site; and
provide notification of the rejection to a respective installation technician generating input.

21. The system as in claim 15, wherein the communication management hardware is further operative to:
perform a preliminary analysis of the first wireless access point providing the wireless coverage at the alternative site; and
produce the performance metric based on the preliminary analysis.

22. The system as in claim 21, wherein the communication management hardware is further operative to:
provide notification of the performance metric to an installation technician for review, the installation technician assigned to install the first wireless access point at the original site; and
receive a message indicating selection of the alternative site by the installation technician in which to install the first wireless access point.

23. The system as in claim 22, wherein the communication management hardware is further operative to:
in response to receiving the message indicating selection of the alternative site by the installation technician, perform a secondary analysis of installing the first wireless access point at the alternative site, the secondary analysis being more robust than the preliminary analysis;
based on the secondary analysis, predict a quality of wireless services associated with installation of the first wireless access point at the alternative site as indicated by the selection; and
generating a decision approving installation of the first wireless access point at the alternative site in response to detecting that the predicted quality of wireless services is above a threshold level.

24. The system as in claim 23, wherein the communication management hardware is further operative to:
communicate the decision in a message over a wireless communication link to the installation technician, the decision in the message prompting the installation technician to install the first wireless access point at the alternative site.

25. The system as in claim 15, wherein the alternative site is a first alternative site;
wherein the wireless coverage is a first wireless coverage;
wherein the performance metric is a first performance metric; and
wherein the input further indicates a second alternative site in which to install the first wireless access point, the second alternative site being different than the original site selected for installation of the first wireless access point.

26. The system as in claim 25, wherein the communication management hardware is further operative to:
predict second wireless coverage associated with installation of the first wireless access point at the second alternative site; and
based on the predicted second wireless coverage, assign a second performance metric to the installation of the first wireless access point at the second alternative site.

27. The system as in claim 26, wherein the communication management hardware is further operative to:
wirelessly communicate the first performance metric and the second performance metric to a technician assigned to installation of the first wireless access point.

28. The system as in claim 27, wherein the first performance metric indicates a first ranking of installing the first wireless access point at the first alternative site;
wherein the second performance metric indicates a second ranking installing the first wireless access point at the second alternative site; and
wherein the second ranking is higher than the first ranking.

29. Computer-readable storage hardware having instructions stored thereon, the instructions, when carried out by computer processor hardware, cause the computer processor hardware to:
receive input indicating an alternative site in which to install a first wireless access point, the alternative site being different than an original site selected for installation of the first wireless access point;
predict a wireless coverage associated with installation of the first wireless access point at the alternative site; and
based on the predicted wireless coverage, assign a performance metric to the installation of the first wireless access point at the alternative site.

30. The method as in claim 1 further comprising:
based on installation of the first wireless access point at the alternative site, storing configuration information indicating modifications to an original installation plan proposing installation of the first wireless access point at the original site, the configuration information indicating attributes associated with installation of the first wireless access point at the alternative site.

32. The method as in claim 1, wherein the first wireless access point is installed in a macro/micro cellular network deployment, where the first wireless access point is mounted over one of: i) a building rooftop, ii) pole, iii) bill-board.
